(19) United States
(12) Patent Application Publication
(10) Pub. No.: US 2014/0199646 A1
(43) Pub. Date: Jul. 17, 2014

(54) Edible Fiber Matrix Candle

(71) Applicant: Eat the Candle, LLC, Lodi, CA (US)

(72) Inventors: Robert Beadles, Lodi, CA (US); Nicole Beadles, Lodi, CA (US)

(73) Assignee: EAT THE CANDLE, LLC, Lodi, CA (US)

(21) Appl. No.: 13/791,963

(22) Filed: Mar. 9, 2013

Related U.S. Application Data
(60) Provisional application No. 61/753,135, filed on Jan. 16, 2013.

(51) Int. Cl. C11C 5/00

(52) U.S. Cl. CPC C11C 5/002
USPC 431/288

(57) ABSTRACT

A festive cake decoration and wax-type confection made of a complex mixture of waxes, organic fibers, sweeteners, and which optionally includes at least one natural gum. The invention is capable of carrying and sustaining a flame when placed adjacent to a source of combustion. Once the invention is lit, the food matter of the invention oxidizes at a temperature of 125° F. (52° C.).

### CROSS REFERENCE TO RELATED APPLICATIONS

This application claims the benefit of U.S. Provisional Application No. 61/753,135 filed Jan. 16, 2013.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM

Not Applicable

### BACKGROUND OF THE INVENTION

1. Field of Invention

The present invention is in the field of festive food decoration. More particularly, to candles which include a decorative, combustible material designed primarily as a food ornament.

2. Description of Related Art

A candle is defined as a usually molded or dipped made of wax or tallow containing a wick that may be burned as to give light, heat, or scent or for celebration for votive purposes. (“candle.” Merriam-Webster.com. 2013. http://www.merriam-webster.com (17 Jan. 2013).) Candles are known for utilizing light associated with combustion to produce lighting and an attractive atmosphere in an area surrounding the candle.

A torch is defined as a burning stick of resinous wood or twists of tow used to give light and usually carried in the hand. (“torch.” Merriam-Webster.com. 2013. http://www.merriam-webster.com (22 Jan. 2013).) Torches also are known for utilizing light to produce an attractive atmosphere; unlike candles, however, torches do not fully burn through and only maintain a flame at one end.

In a traditional art candle, when source of combustion (such as a match) is placed adjacent to the upper end of the wick, so that the wick begins to burn, the wick undergoes a combustion reaction where hydrogen, carbon and oxygen forming the cellulose molecule (or other hydrocarbon or other combustible composition) undergoes oxidation in the form of a combustion reaction. Most wax near the hottest outermost area of the flame will completely vaporize; however, vaporized wax that is not near the hottest portion of the flame or in an area where there is insufficient oxygen will become partially vaporized. This partial vaporization of the wax causes the wax to expand considerably, or melt. Traditional candle wax will melt at a temperature of approximately between 99° F. (37° C.) and 149° F. (65° C.), depending on material. As a result of this combustion reaction, a flame hovers above the wick; while, above the flame, the vapors rise under natural convection and other partially oxidized wax melts down the side of the candle.

It is a custom to use a candle as an ornament on top of cakes, cupcakes, cookies, pies, ice cream, or other food products at festive occasions like a child's baptism, birthday party, anniversary parties, graduations, weddings, and other holidays. Conventional festive cake decorations, like birthday candles, are made up of entirely of wax and a wick, for the purpose of producing a festive atmosphere or lighting through the above described process of oxidation. Wax that is not used during the process of oxidation by the wick, however, drips onto the cake or related food product. Today, most candles are made of paraffin wax or tallow. Parafin wax, though edible, is non-digestible and flavorless. Tallow is made of rendered beef fat. These properties of traditional candle wax make them undesirable to those observing kosher, vegetarian or halal diets. Further, the removal of the unused wax damages the food product by making it visually unattractive and quite often ruins the flavor of the birthday cake or similar food product.

A typical candle is described in Baumer, U.S. Pat. No. 1,958,462. Edible waxes of a food grade nature have been mentioned in Forkner, U.S. Pat. No. 3,860,731, which mentions both tallow (hydrogenated fat and oil) based and wax based.

An edible candle that compromises an edible wick is described in Schuppan, U.S. Pat. No. 6,099,877. Schuppan discloses a wax component, made of vegetable fat, cocoa and dextrose; Schuppan also discloses a wick made of Durasorb II and silica gel or a wick made of stearic acid, silica gel, wheat fiber and maltodextrin. Although described as a non-string wick, the internal wick disclosed by Schuppan remains very granular and results in a wick that is: sinewy, tasteless, indigestible and may be a food hazard to small children. Further, because of the lack of a string wick, Schuppan edible candle commonly requires relighting, difficult to light and often does not burn through fully.

While generally effective, such materials can be improved upon in a variety of different ways to provide various unique benefits. This present invention seeks to improve upon such problems.

### SUMMARY OF THE INVENTION

The present invention is a candle to be used as an edible food decoration. The invention is designed to be planted on top of a cake, cupcake, cookies, pies or related festive food. The extruded present invention is designed to bear and sustain a flame for a period at the vertical tip of the invention.

The present invention has the goal of being edible, either unignited, partially ignited or fully ignited. Further, the partially oxidized wax remains of this present invention are designed to be edible.

The present invention also has the goal of being, at least in one embodiment, of a vanilla, chocolate, berry or otherwise flavor.

One embodiment of this invention affords a single unit candle-like form which oxidizes at a temperature of 125° F. (52° C.) The may be entirely composed of waxes and organic fibers to form a single unit fiber matrix. This candle matrix sustains a flame without the use of a traditional wick. This embodiment has the optional inclusion of one or more food grade gums, external spray, flavor or pigmented coating and may be designed into unusual shapes.

Another embodiment of this present resembles more of an edible torch, made up of two part components: first, an edible food stuff gelatin-based candle base; and second, an edible flammable fiber matrix. The first component is an edible food stuff made from a gelatin-based candy or other food stuff molded into a column or other shape. This first food stuff component is affixed on top of the food product or birthday cake. This first component has been extruded in such a way that an empty cavity is formed in the food stuff. The purpose of this cavity is to provide a basin in which the second component of this present embodiment may be impregnated. The second component of this present embodiment is the flammable and edible fiber matrix of this present invention. This edible fiber matrix is planted into the cavity of the first gummy component. The second component, in this present embodiment, does not run throughout the interior like a wick of traditional candle. Under this embodiment, one ignites the top of this present embodiment by placing a source of combustion near it. The flame carries through the second component, but the flame is not intense enough to combust the second component of this present embodiment. In this present embodiment, the flame will maintain itself only in the cavity created and filled with the ignitable fiber matrix, supported by the food stuffs of the first component. The food stuff candle base component ideally will not ignite because of a higher point of oxidation, or lack of heat intensity or because the food stuff contains too much water. Under the present embodiment, the user may eat the candle ignited, unignited or partially ignited.

Another embodiment of the present invention may be more like a traditional candle with an edible wick an edible outer encasement. This embodiment includes an edible wick that is surrounded by an edible outer encasement.

The present invention optionally may contain one or more food grade gums, external spray, flavor or pigmented coating and designed in many shapes.

### BRIEF DESCRIPTION OF THE DRAWINGS

FIG. 1 is a front view of a festive cake decoration of the present invention; however, the present invention is not limited to the precise arrangements depicted in the drawing.

FIG. 2 is a perspective view of a festive cake decoration of the present invention affixed upon a birthday cake. This view of the candle includes a cross-section of the candle according to its present invention. This precise arrangement is just another embodiment of the invention.

FIG. 3 is a front view of a festive cake decoration of the present invention. This view of the candle is a view of the outer coat of the candle after it has been dipped or sprayed in external coating. The present invention is not limited to the precise arrangements depicted in the drawing.

FIG. 4 is a cross sectional view of one embodiment of this present invention, where this present invention is more similar to that of a traditional torch than a candle. FIG. 4 depicts the two parts of this present embodiment physically disassembled. The two parts are: first, an outer food stuff gummy base with extrusion located at the crown; second, an inner edible fiber matrix flammable insert.

FIG. 5 is a cross sectional view of the same embodiment depicted in FIG. 4. FIG. 5 depicts the a fully assembled candle of this present invention. FIG. 5 further depicts an unlit candle or torch.

FIG. 6 is a cross sectional view of the same embodiment depicted in FIG. 4. FIG. 6 depicts a fully assembled candle of this present invention a flame. FIG. 5 includes a flame and a smoke plume.

FIG. 7 is a cross sectional view of the same embodiment depicted in FIG. 4. FIG. 4 depicts a fully assembled candle of this present invention after it has been fully incinerated. In FIG. 7, the edible flammable fiber matrix component of this present invention has been consumed and all that remains is the edible outer food stuff.

FIG. 8 is a cross-sectional view of a non-limiting configuration of one embodiment of this present invention that depicts an embodiment that is similar to FIG. 4-7. The embodiment depicted in FIG. 8 is composed of two parts: the first, an outer food stuffs gummy base; the second, an inner edible fiber matrix. Unlike the embodiment depicted in FIG. 4-7, the embodiment show in FIG. 8 has the edible fiber matrix running throughout.

FIG. 9 is a non-limiting representation of six example combustible cake decorations this present invention may be molded into.

FIG. 10 is a cross sectional view of a non-limiting configuration of the embodiment disclosed in FIG. 5, FIG. 6, FIG. 7 and FIG. 8. The present embodiment has been molded to resemble a volcano and is depicted sitting atop a cake.

### DETAILED DESCRIPTION

The candle of the present invention solves these problems and other problems by providing a true non-wick formula made from a fiber matrix of this present invention that is edible. Another embodiment of this present invention includes a wick portion out of edible material implanted within a moderation portion out of edible material. Illustrative examples of such embodiments are explained in much more detail infra.

In either form, the candle is entirely edible. When ingredients of the candle are referred to as “edible,” materials which might theoretically not harm the body when consumed are not referenced, but rather materials which are both not harmful when eaten, but also provide at least some beneficial caloric energy to the human body and which are materials which are already enjoyed by a substantial percentage of the human population when not in candle form as edible food items, and/or which are generally regarded individually as being food items.

With the edible candle of this invention a method of enjoyment can be provided and varied by a user. In one embodiment the candle is merely lit as a novelty dessert item and served with the wick portion a flame. A consumer can choose to allow the candle to burn out through the entire wick column and then eat the remaining food product, or can blow out the candle and eat all remaining portions of the candle. The edible candle could also conceivably be eaten without even being first lit. The candle could be eaten quickly when the moderator is still partially molten or could be allowed to cool and re-harden before being consumed. While it is typically expected that the candles would be eaten after their first use, it is conceivable that the candles could be relit and reused until the fiber matrix or wick column has been entirely consumed.

The present invention can be modified into different shapes. Such shapes the present invention could be molded into include: numbers, letters, symbols, animals, smiley faces, roses, volcanoes or any other common-place easily recognizable symbol, unless not permitted under law. The present invention also refers to adding an outer coating may be sprayed in apparent various color schemes for various festive events. Additionally, a scent component may be added onto this present invention.

When structures are identified as a means to perform a function, the identification is intended as being coupled together, such language should be interpreted broadly to include the structures being coupled together through intervening structures. Such coupling could be permanent or temporary and either in rigid fashion or in any fashion which allows pivoting, sliding or other relative motion while still providing some form of attachment, unless specifically restricted.

The fiber matrix embodiment of the present invention may be composed of any type of food grade wax (including, but not limited to, parawax, paraffin wax, palm wax, coconut wax, soy wax, Palmin brand wax) or oils, natural or artificial sugars, and organic fiber material, along with a mixture of water, propylene glycol, natural gums, sweeteners and preservatives. Additional ingredients may be spray added onto the present embodiment to maintain the food good's freshness, the product's melting point and to provide for proper oxidation of the product.

A typical fiber matrix edible candle according to the present invention can be made as such: prepare a melting pot for a mixture of wax, sugar, flavorings, gums, preservatives, scents, sweeteners and other ingredients. The fiber matrix of this present invention is then prepared separately. The fiber matrix component of this present invention may be made by hand loosely intertwining very fine organic fiber found in: nuts and seeds, potato skins, buckwheat, whole grain foods, wheat and corn bran, celery, tomato skins, kiwifruit skins, cotton, hemp, organic fiber or other types of fiber. Alternatively, under this present invention, a fiber matrix may be made by loosely intertwining fiber to form a sponge. This fiber matrix material should be placed into an empty mold. Turning back to the mixture in a melting pot, according to the traditional method of making a candle, add the melted ingredients to a mold that contains a suspended organic fiber matrix material. The fiber matrix must be distributed equally through the mold, sufficient to stably maintain a flame throughout the candle. The finished candle may then be cut according to suitable mold or intended design, with no exposed wick necessary.

According to this embodiment of this present invention and this method of production, the above described embodiment can be employed in a variety of different shapes that are unavailable for a traditional candle. Since this embodiment of the present invention contains embedded edible fiber matrix and no wick, various candle shapes are possible in this present invention that would not otherwise be possible with a traditional art candle that requires a vertical wick. This embodiment of the present invention allows for unusual shapes because the present invention may be cast into a variety of different shapes without the limitations inherent in a traditional wick. Additionally, it may burn differently depending on the particular shape or design. A fiber matrix candle mold may contain portions with no blended fiber material to obtain a favorable burn suitable to the shape.

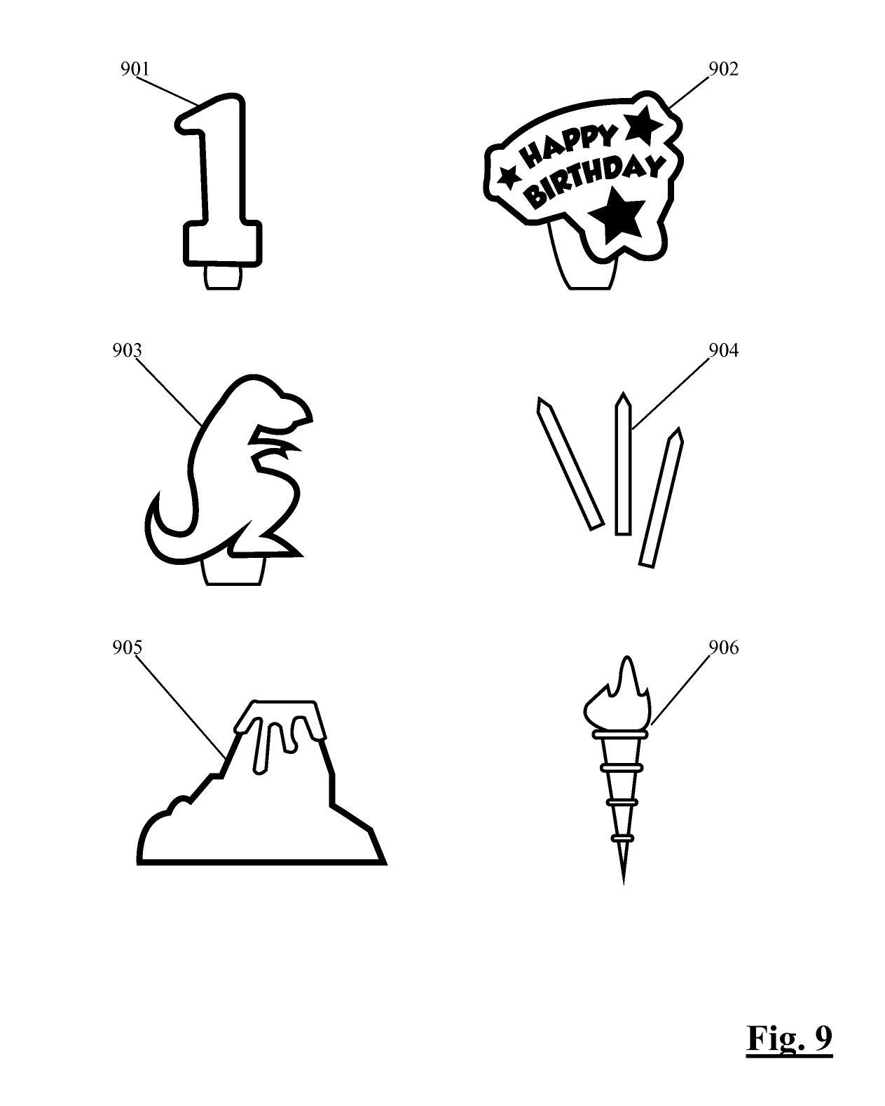

Turning now to FIG. 9, FIG. 9 shows six non-limiting example shapes that this present invention may be designed into. The present invention may be molded into the shape of a number ‘1’ 901. The present invention may be molded into an unusual shape 902 with pixel additives inserted to relay a message, such as “happy birthday.” The present invention may be molded into animal or other easily recognizable shapes 903, such as a dinosaur 903. The present invention may be molded into a cylindrical striped and colored shape 904, to resemble that of a traditional candle. The present invention may be molded into a volcano shape 905. The present invention may be molded into a torch shape 906. In any shape, the entire candle may made up the edible fiber matrix and flammable or the candle may contain an inner flammable fiber matrix with an outer edible food stuff. This shapes disclosed above are by no means exhaustive and there are an infinite amount of readily recognizable shapes, figures, symbols and other forms in which the present invention may be turned into.

The traditional candle embodiment of this present invention may have an inner wick column surrounded by an outer column of edible wax or edible food stuffs. The inner wick column may be composed of organic fiber. The outer wax column of this present invention may be composed of a combination of wax (including, but not limited to, parawax, paraffin wax, palm wax, coconut wax, soy wax, Palmin brand wax) or oil, sugar and preservatives and flavorings. An additional outer coat may be sprayed on to this candle for a preservative function, decoration, taste function, or scent function; composed of such things as pigment, paraffin wax, flavoring, scents or the like.

A typical traditional candle embodiment is made as such: prepare the edible organic fiber by removing the fiber from the spool. The fiber should be thick enough to support a flame. In accordance with the traditional candle making method, dip this organic fiber repeatedly in the melted wax ingredients. The finish product may be variously shaped and cut into a desired length. With a knife or similar tool, leave ½ to 1 inch of organic fiber exposed at the tip of the candle to form the wick.

In another preferred embodiment of this present invention, which resembles more of a torch than a candle, the candle is made up of two parts: the first, an edible food stuff candle base; the second, a flammable edible fiber matrix of this present invention. The first part is composed of edible food stuffs including: gummy candy, jelly sweets, gummy bears, gummy worms, marshmallows, fruit drops, Swedish fish, other gelatin-based chewy candy, licorice, jelly beans, bubble gum, chocolate, white chocolate, nuts, fondant, toffee, coconut, marzipan or other preferred ingredients. Gelatin-based chewy candy, according to this present invention may be made from a combination of: gelatin, sugar or artificial sugar, flavoring, water, edible wax, lecithin, anti-foaming agents, and other preservatives. The second part of this preferred embodiment is the edible fiber matrix of this present invention described earlier in this disclosure, and made from a combination of: wax, organic fiber, sugar or artificial sweetener, natural or artificial flavoring, pigment, preservatives, and propylene glycol. The second part, the edible flammable part, may be made up of 140R or paraffin wax, baker's sugar, zinc oxide, sodium chloride and corn fiber.

A typical torch of the above described preferred embodiment can be made as such: in a melting pot over medium heat, combine all the ingredients and stir until the mixture is fully dissolved. After the gelatin mixture has cooled, the gelatin will be placed into a mold. This mold may be of any shape. Ideally, this mold will have a crown or extruded portion on top of the desired shape to place the flammable edible fiber matrix. Alternatively, one may create such an empty cavity by extruding a top portion of the gelatin dessert. Once cooled, the candy base of the present invention is to be removed from the present invention. Turning to the second part of this preferred embodiment, the edible fiber matrix of this present invention is to fit within the cavity present in the first edible candy base. The edible fiber matrix should also have a pointed cone tip for easy lighting. Once created (by the process previously discussed in this present invention), the edible fiber is to be affixed with or without adhesive on top of the food stuff base of this present invention.

A formula of the ingredients found to provide the vanilla flavoring in the melted wax, fiber matrix, or outer coating would include the following: cocoa butter, powdered sugar, powdered milk or soymilk powder, vanilla extract, salt, and sugar or an artificial sweetener. An alternative formula of ingredients found to provide the chocolate flavoring in the melted wax, fiber matrix or outer coating would include the following: cocoa beans or cocoa powder, cocoa butter, milk powder or soymilk powder, natural or artificial sweetener, and lecithin. A further alternative formula found to provide the berry, cinnamon, almond, banana, butter, coconut hazelnut, maple, rum, strawberry, anise, coffee, lemon, mint, orange, peppermint, raspberry, root beer, lime, cola, apple, melon, mango, pineapple, cherry, pumpkin, lavender, ginger or similar flavor would include the following: cocoa butter, powdered sugar, powdered milk or soymilk powder, salt, natural or an artificial sweetener and extract or artificial flavoring of the desired flavoring. All above flavors may contain natural or artificial preservatives, to control decay; natural or artificial gums, to act as a thickening, gelling, stabling or emulsifying agent; natural or artificial pigments to correspond to their flavor; or other components to control burning temperatures. Additionally, the above formula may contain pleasant scents that correspond to the flavors.

In a further embodiment of this present invention, decorative fixtures may be affixed to the present invention. Such things like sprinkles, stripes, stars, chips and the like. Alternatively, fixtures may be added onto the present invention to form a more complete complex design. For example, edible wax is rolled out and carved out to form a palm tree and affixed to the present invention when the present invention is shaped as a volcano, to create a more complete design.

The present invention, and its embodiments, have a preferred melting temperature as follow, subject to additives:
fiber matrix embodiment of the present invention melts at the following range: 130° F. (54° C.) and 200° F. (93° C.);
organic fiber of the traditional candle embodiment of the present invention melts at the following range: 250° F. (121° C.) and 300° F. (149° C.);
wax outer casing of the traditional candle embodiment of the present invention melts at the following range: 120° F. (49° C.) and 180° F. (82° C.);
gelatin-based candle base of the torch candle embodiment of this present invention melts at the following range: 110° F. (43° C.) and 130° F. (54° C.);

external spray on or dipped wax coating formula with flavorings, melts at the following range: 120° F. (49° C.) and 180° F. (82° C.).

### EXAMPLE 1

Non-limiting examples of formulas used in the present invention are as follow:

| | Weight % |
|---|---|
| Fiber Matrix Formula “A” | |
| Wax | 65.50% |
| Organic Fiber | 12.99% |
| Sugar | 16.23% |
| Flavor | 3.250% |
| Pigment | 1.01% |
| Preservative | 1.01% |
| Propylene Glycol | 1.01% |
| | 100% |
| Fiber Matrix Formula “B” | |
| Parafin Wax or 140 R Wax | 66.67% |
| Baker's Sugar | 6.67% |
| Zinc Oxide | 6.67% |
| Sodium Chloride | 6.67% |
| Corn Fiber | 13.33% |
| | 100% |
| External Sprayed on or Dipped Wax Coating Formula “A” | |
| Acacia gum | 10.00% |
| Wax | 80.00% |
| Pigment | 5.00% |
| Flavoring | 5.00% |
| | 100% |
| Edible Wick Encased in Wax Formula “A” | |
| Refined Food Grade Wax Material | 70.00% |
| Organic Fiber material | 20.00% |
| Organic Sweetener | 10.00% |
| | 100% |
| Flavoring Formula “A” | |
| Cocoa Butter | 50.00% |
| Powdered Sugar or Artificial Sweetener | 20.00% |
| Powdered Milk or Soymilk Powder | 28.00% |
| Vanilla Extract or Cocoa Powder or Other Flavors | 2.00% |
| | 100% |
| Gelatin Based Candle Base Formula “A” | |
| Unflavored Gelatin | 20.00% |
| Sugar or artificial sweetener | 50.00% |
| Corn Starch | 24.00% |
| Water | 2.00% |
| Pigment | 1.00% |
| Preservatives | 1.00% |
| Edible Wax | 0.5% |
| Lecithin | 0.50 |
| Anti-Foaming Agent | 1.0% |
| | 100% |

### EXAMPLE 2

### Fiber Matrix Candle with Cone Top and No Outer Coating

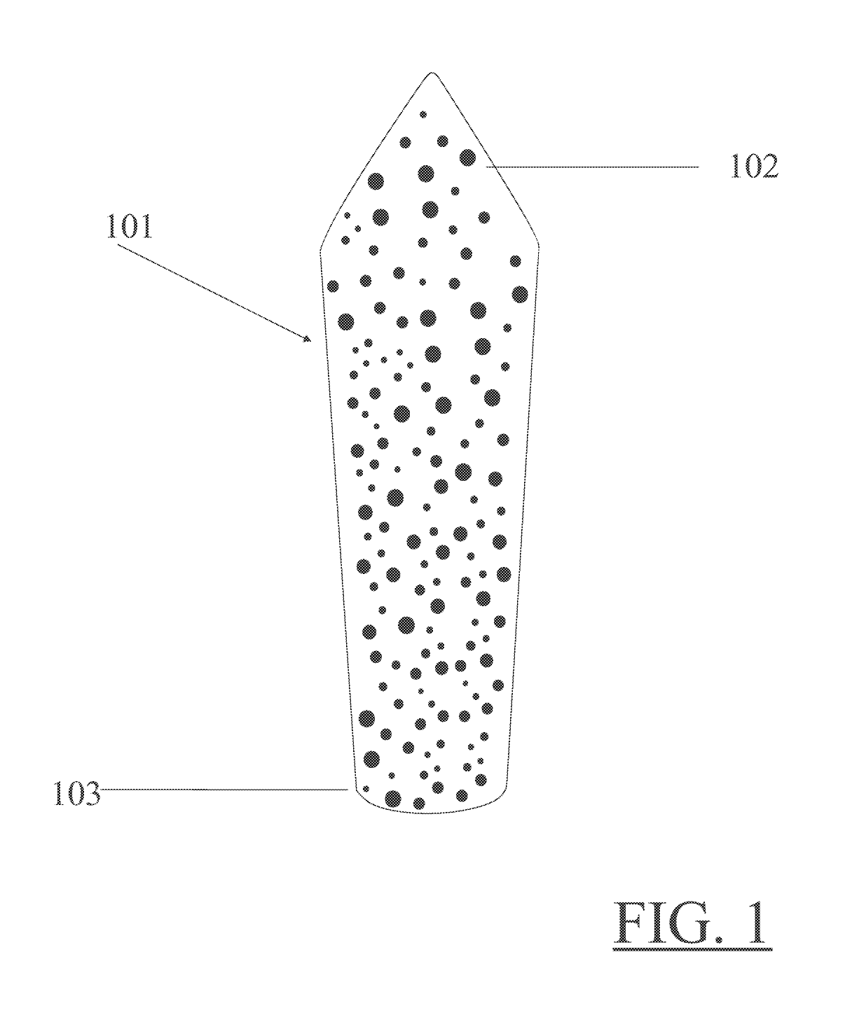

In one embodiment, the candle has a somewhat pyramid top shape with a wide base and a narrow top with a cylindrical column passing vertically thorough the center thereof. Referring to FIG. 1, the candle 101 is a food product, composed of: propylene glycol, water, pigments, preservatives, flavorings, starches and organic fibers; as demonstrated in the above combined fiber matrix formula “A.”

This candle is entirely edible, either ignited, un-ignited or partially ignited. The flavor of the body of the candle is preferably chocolate, vanilla, berry and/or other similar flavorings. Flavor can be added using the Flavor Formula “A” of example 1. Added flavors will alter the formula recited above.

This combination of food product creates a fiber matrix and has its source of ignition at the top tip of the cone of the candle 102. This fiber matrix, through imbedded natural fibers, requires no wick to burn. When a source of ignition is placed near the top of the candle 102, the candle is ignited with the fiber matrix becomes inflamed. The fiber matrix and food product melt together and eventually cascade down the outer sides. The flame maintains itself on the pointed tip of the candle. This example candle does not require a wick found in traditional art candles, but instead the entire cone top is ignited and burned down completely, leaving only residue.

This current embodiment of the candle has a cylindrical base 103 which is used to affix the candle atop of a birthday candle, cupcake or similar food product. The top of the candle 102 is somewhat pyramid in shape, and a cylindrical column runs vertically throughout the candle. However, the current embodiment of this candle may be molded into various shapes and sizes according to different molds that the fiber matrix invention is cast into. The present invention is not limited to arrangements described in this current example.

### EXAMPLE 3

The fiber matrix cylindrical candle made in example 2 may also be, by example, molded into a silicone mold that resembled the shape of a volcano. The candle of this present invention is created by traditional methods by the use of a mold. The mold was prepared by placing fiber matrix fibers throughout. In a separate pot over flame, a mixture was made using the combined fiber matrix formula “A”, with the addition of chocolate flavoring, natural gums, and additives. Natural gums are necessary to thicken and allow the chocolate flavoring to mix with the wax. Additives were necessary to maintain an ideal burning temperature once the fiber matrix candle began to sustain a flame. Once the mixture was poured into the mold, an outer shell, using the ingredients in external sprayed on or dipped wax coating formula “A,” were added on to provide for a preservative, more attractive color and a canvas to hand paint details. The resulting candle pleasantly burned and was edible fully melted, partially melted or unmelted. This embodiment of the present invention may be made into a number of shapes.

### EXAMPLE 4

### Fiber Matrix Candle with Cone Top and Outer Coating

The fiber matrix candle as made in Example 2 is used backbone to this alternative embodiment. From the no-wick core, as made in Example 2, an outer coating is added to more accurately stimulate the appearance of other festive candles.

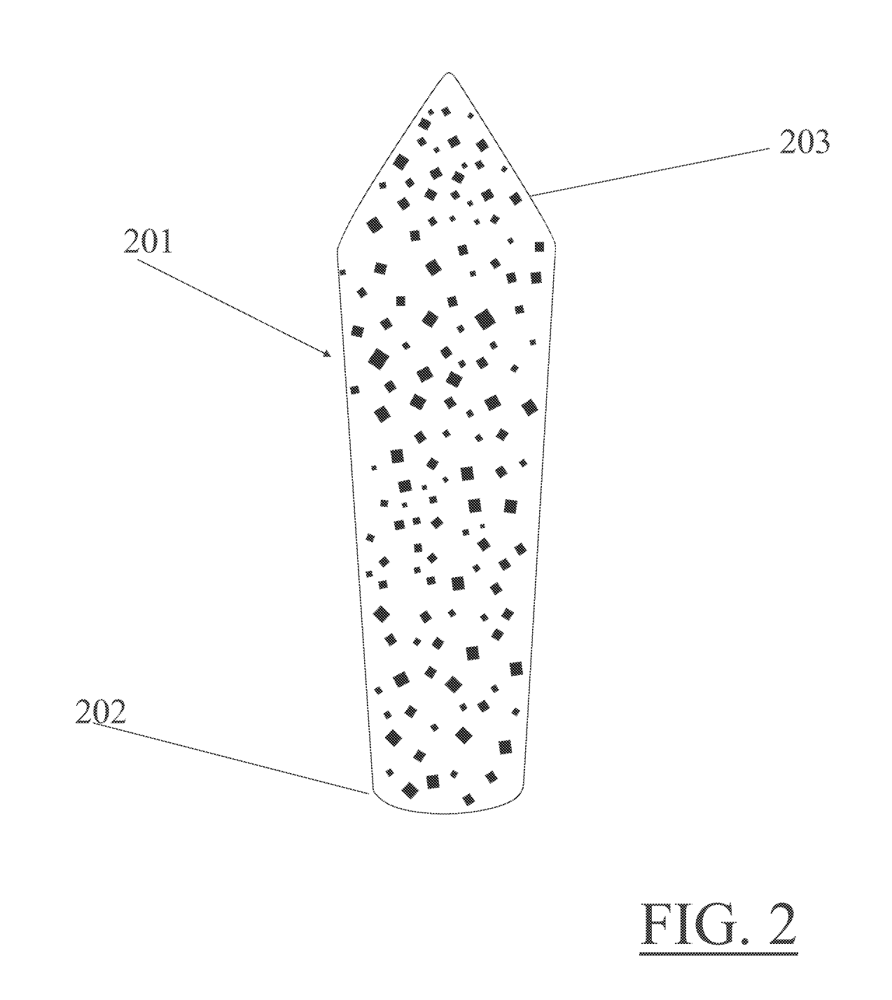

Referring to FIG. 2, the candle 201 has a cylindrical base 202 and has a cylindrical column vertically running through the candle. Similar to Example 2, an identical cone-like top makes up the head of the candle 203. This candle is made of a flammable fiber matrix, as described above in Example 2 and described in fiber matrix formula “A”. This fiber matrix is entirely edible and made of common food stuffs. The current embodiment of this example may be molded into various shapes and sizes according to different molds that the fiber matrix invention is cast into and is not limited to the arrangement currently described.

The outer coating is made from a combination of wax, gum, pigment and flavoring, as described in external sprayed on or dipped wax coating formula “A”. It is to be applied to the candle by dipping, spraying or other similar coating method. This outer coating may be in a variety of different flavors, colors, or fixtures. Such fixtures may include festive sprinkles, designs, textures, shapes, candies, chocolates, polka-dots, fondant, stripes, letterings, symbols, nonpareils and the like. The outer coating may be colored thematically to match particular festive occasions including: birthday parties, birth of a new child, sport colors, school colors, university colors, national colors, holiday colors, and other similar festive coloring schemes.

### EXAMPLE 5

### Other Shapes Fiber Matrix Candle with No Wick

Other shapes of the edible candle described as made in Example 2, Example 3 and Example 4 could include tall thin candles such as typically used on birthday cakes, as well as candles having other shapes which can be in the form of recognizable objects. The outer fiber matrix might be molded or otherwise formed into the shape of figurines of animals, individual's numbers, letters or other recognizable items. The fiber matrix candle may be crafted into these various unusual shapes by silicone, aluminum or other molds. In general, all shapes which are known in the prior art to be provided for prior art candles can be substituted with this invention. FIG. 9 shows a few examples of some possible shapes. This candle will be entirely edible unignited, partially ignited or fully ignited.

### EXAMPLE 6

### Edible Cylindrical Candle with Edible Wick

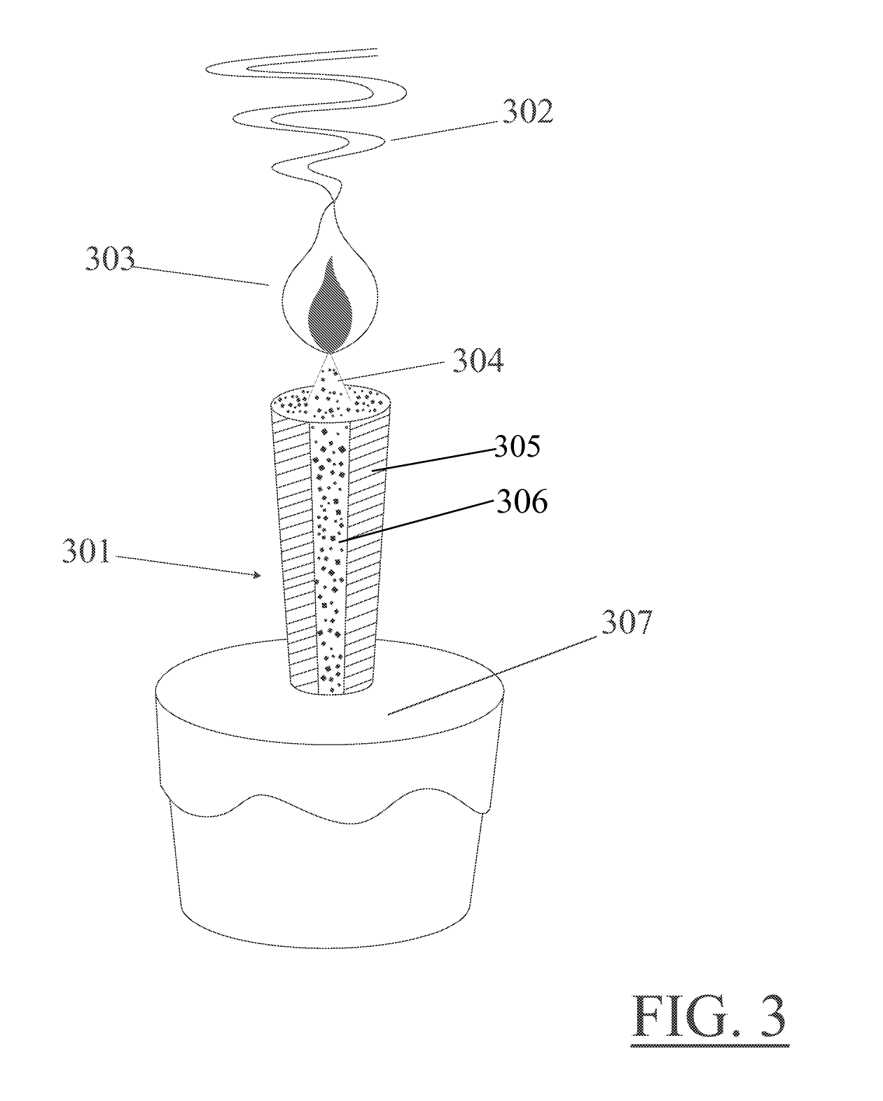

Another embodiment of this edible candle is seen in FIG. 3. FIG. 3 is a cross sectional view of the body of a candle 301 that is somewhat cylindrical in shape and affixed on top of a birthday cake 307.

This embodiment resembles that of a more traditional art candle. This candle is made up of a two parts. The first part, an inner fiber matrix wick 306, made out of an organic fiber, food grade wax and sweetener. This edible wick is centered within the candle. The column form for the wick portion is preferably elongate and substantially vertical with proportions which are taller than wide. With such an elongated orientation and with an orientation extending substantially vertically, the wick portion can beneficially function as a portion of a candle where natural convection effectively works to allow the candle to burn for a prolonged period of time, compared to what would otherwise be the duration of burn time if the wick portion were not elongate or where not orientated vertically.

The second part of this embodiment is an edible, outer shell 305 that surrounds the inner wick. This edible outer moderator would beneficially have a melting point just above room temperature and a smooth consistency somewhat similar to wax. Preferably, this outer moderator would be made of a mixture of propylene glycol, water, pigments, preservatives and flavorings. This outer moderator would surround the inner wick and provide it a fuel from which to oxidize from 304. Preferably, this outer moderator would be vertically arranged for maximum efficient natural convection.

Both portions of this embodiment, indeed the entire embodiment itself, is made of edible food stuffs. It may be consumed unignited, partially ignited or fully ignited. The flavor of this embodiment may be vanilla, chocolate, berry or other flavorings. It may also be surrounded by an external edible coat or spray, as seen in Example 3 or 4 and contain similar thematic colorings, fixtures and shapes.

Still referring to FIG. 3, when a source of ignition is placed near the top of the candle 304, the candle is ignited with the fiber matrix becomes inflamed 303. Once a flame at 303, the wax within the edible fiber matrix fuels the fire and may use the outside edible food stuffs as fuel.

Still referring to FIG. 3, the current embodiment of this candle, 6, has a wide flat base, which is used to affix the candle atop of a birthday candle, cupcake or similar food product. However, the present invention is not limited to the description provided above or the illustration provided in FIG. 3.

### EXAMPLE 7

### Edible Torch with Fiber Matrix Inserted at Crown

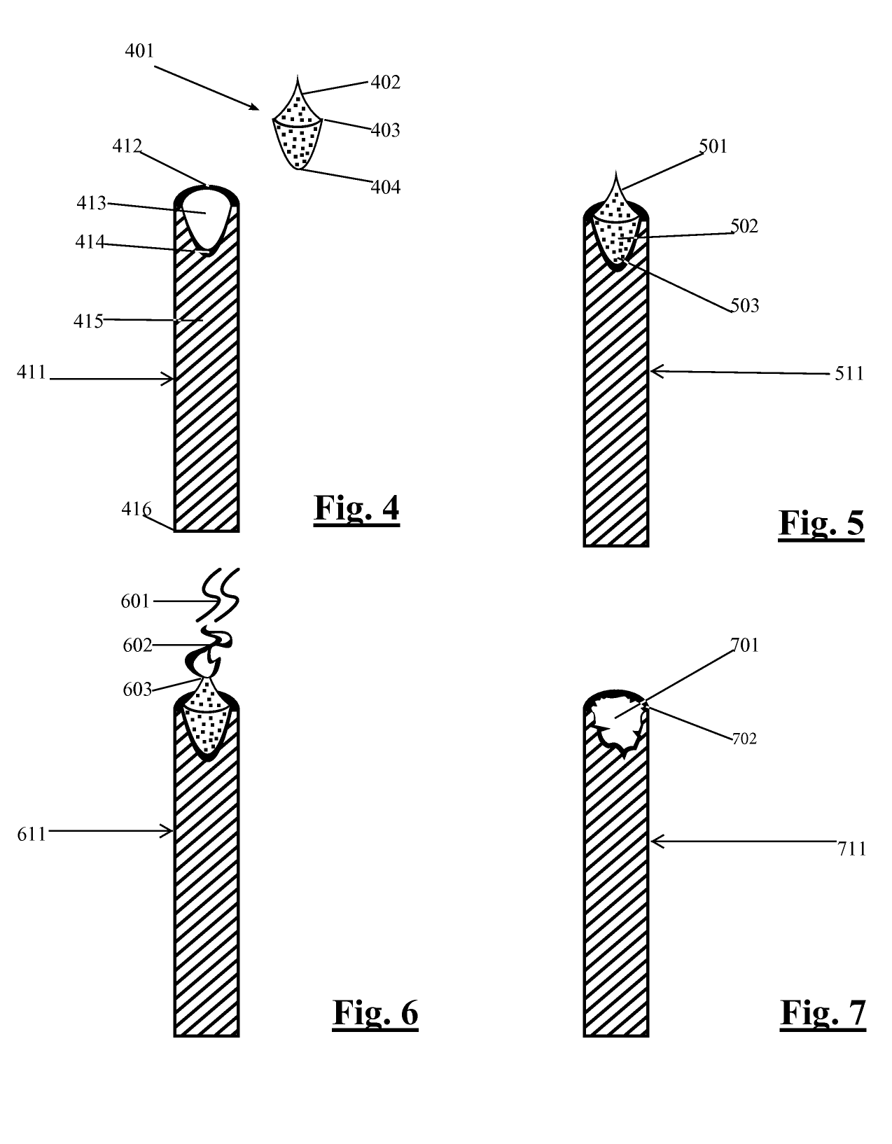

Another embodiment of this present invention is seen in FIG. 4. FIG. 4 depicts a disassembled edible candle of this present invention. This present embodiment is made up of two parts: the first, an edible candle base 411; the second, an edible flammable fiber matrix insert 401. The edible candle base 411 is made entirely from food stuff. In one version, the edible candle base 411 is made from a gelatin-based candy recipe disclosed as Gelatin Base Candle Formula “A.” However, the candle base of present embodiment may be made for a variety of different materials; other possibilities include: licorice, gum, gum drops, chocolate, vanilla, marshmallows or other gelatin-based candies. This candle is affixed atop a cake or food 416. At the crown of this candle 412 a cavity is present 413 that is deep enough 414 to comfortably fit the second flammable part depending on the length of flame desired. The second component, the edible fiber matrix 401, contains is molded in such a way 403 that it will fit within the cavity of the candle base 404. This edible fiber matrix is made from a combination of 140R or Parafinn wax, baker's sugar, zinc oxide, sodium chloride, and corn fiber. One sample configuration is disclosed in Fiber Matrix Recipe “B.” The fiber matrix flammable component, also has a cone shaped tip 402 for ease and convenience of ignition.

Turning now to FIG. 5, FIG. 5 depicts a cross sectional view an assembled version of this candle with both the edible fiber matrix and the candle base attached 511. As shown, fiber matrix insert rests comfortably inside the cavity 502 all the way to the bottom 503. Finally, the candle 511, contains a no-wick tip for easy ignition.

Turning to FIG. 6, FIG. 6 depicts a cross sectional view of this current embodiment fully ablaze 611. There is a fire 602 at the cone top 603 of the candle 611. Under this current embodiment, the flame maintains itself within the edible fiber matrix insert. Similar to a torch, the candle base does not ignite because of a lower melting point, or a high water content, or a lack of flame intensity. The surrounding food stuffs may maintain the flame by capillary action.

Turning to FIG. 7, FIG. 7 is a cross sectional view of this current embodiment after extinguishment of the flame 711. In this embodiment, the flame could either be manually extinguished by a user or a result of the burning of the fiber matrix. After extinguishing the candle, a melted food base 702 remains and the cavity 701 remain.

The candle of this current embodiment is edible in unignited, partially ignited and fully ignited. An external dipping or spray may be added onto the candle of this current embodiment that may contain external coloring, fixtures, spray or other decorative elements. Additionally, the candle base of this present embodiment may be of a variety of flavors. Finally, a variety of different shapes are possible for this current embodiment including alphabetic letters, Arabic numerals, shapes, easily recognizable objects, animals and other common figures.

### EXAMPLE 8

### Edible Torch with Internal Fiber Matrix

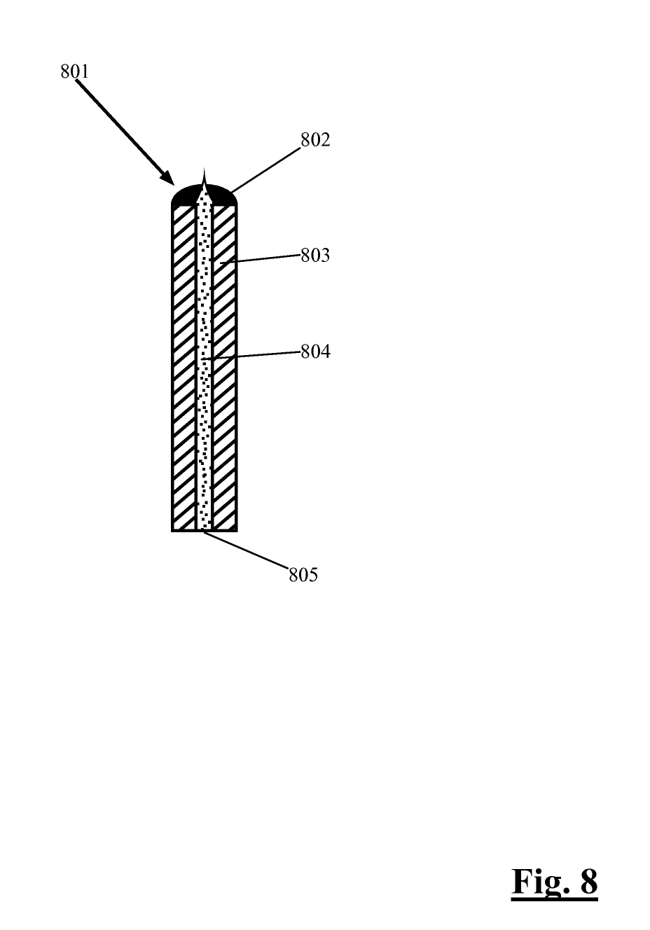

Another embodiment of this present invention is similar to the one version disclosed in Example 6, except that an edible fiber matrix will run throughout the outer food stuff of the candle. Turning to FIG. 8, which is a depiction of one embodiment of the present invention, the candle described in this example is shown. This candle 801 is composed of two parts: first, an outer edible food stuff 803; second, an inner fiber matrix that runs through the interior of the first outer edible food stuff 804.

Ideally, as seen in example 7, the outer edible food stuff may be made from gelatin-based food stuff, gum, licorice, gum, gum drops, chocolate or vanilla. In this example, the first edible outer food stuff 804 is composed of a gelatin-based candy as disclosed in Gelatin Based Candle Base Recipe “A.” The second component of this example, the edible fiber matrix, is made according to the method provided in this present invention and may be made in one embodiment be made according to the Fiber Matrix Formula “B,” seen in Example 1. To assemble this candle, the outer edible food stuff 803 may be poured into a mold that has a cavity in the interior. Alternatively, the outer edible food stuff 803 may be molded into a single piece and subsequently have the interior of the candle extracted with a drill. The second component of this candle, the edible inner fiber matrix 804, may be poured into the candle before while it is molten, or placed into a corresponding cast and assembled within the candle.

This candle 801 mentioned in this present embodiment is designed to burn all the way through like a traditional candle, although it may be consumed at any stage of ignition. This candle may be molded into any easily recognizable shape, including: numbers, letters, symbols, animal figures, volcanos, figurines, sports symbols and other shapes. When this candle of this present embodiment is molded into a different shape, different molding methods will be required for the outer food stuffs and inner fiber matrix. Additionally, this candle may be covered by various flavorings, external pigmentations, and fixtures.

### EXAMPLE 9

### Edible Volcano Torch with Inserted Fiber Matrix at Crown

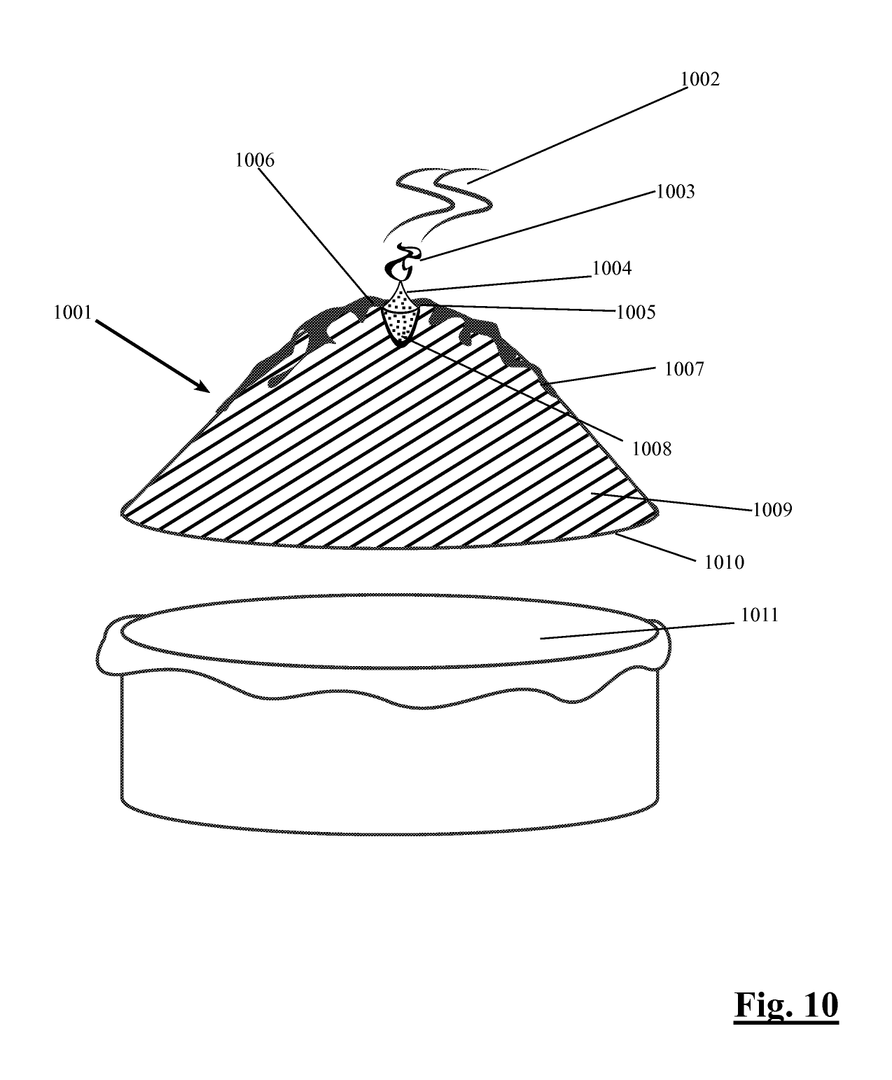

The edible torch candle of Example 7 is used as the backbone of this present embodiment. FIG. 10 is a cross sectional depiction of this present embodiment, which resembles an active volcano shaped candle on top of a birthday cake 1001. This present embodiment is again composed of two parts: first, an edible food stuff 1009 meant to replicate the outer volcano land mass; second, an inner fiber matrix 1008 meant to replicate the molten lava of an active volcano. The inner land mass may be made out of a gelatin-based food stuff, chocolate based food stuff or other common edible candies. It also may be externally coated with spray, pigments or fixtures to create a more realistic impression of an active volcano. Additionally, the inner fiber matrix 1008 is made according to the method provided in this present invention. The inner fiber matrix 1008 is only shown as being impregnated into the cavity created in the outer food stuffs in this present embodiment, but may under additional embodiments run throughout the candle as shown in Example 8. The inner fiber matrix may be pigmented to more accurately stimulate the color of lava, and has a cone tip 1004 for easy ignition.

When a source of combustion (like a match) placed near the cone tip 1004 of this present embodiment, a flame occurs 1003 that results in the oxidation of the inner fiber matrix 1008 and a small smoke plume 1002. Next, the fiber matrix 1005 is enflamed and slowly used up. Some of the surrounding outer edible food stuff 1009 may maintain the flame through capillary action 1006, however the outer food stuff is not to be enflamed entirely. After burning, the torch of this present invention will cause drippings 1007 of mixed fiber matrix and edible food stuffs that are designed to stimulate the flow of lava in an active volcano. Once extinguished, the edible volcano torch of this present invention is entirely edible. It may be placed a top of a cake 1011 by putting the bottom on it 1010.

These disclosures and the above embodiment examples are provided to reveal a preferred embodiment of the invention and some of the best mode for practicing the invention. Having thus described the invention in this way, it should be apparent that various different modifications can be made to the preferred embodiment without departing from the scope and spirit of this invention disclosure.

1. An edible solid single unit wick-less candle compromising in combination:
a fiber matrix component capable of wicking composed of loosely interwoven or spongy fine organic fibers ;
an edible moderator and fuel mixed within and combined directly with the fiber matrix component;
the combination of which is solid at room temperature and melting at a temperature which is reached when undergoing a combustion reaction; and
said edible single unit candle being capable of maintaining a flame when undergoing a combustion reaction.

2. A combination of claim 1 wherein the mentioned single unit wick-less candle may be varied by adding sweeteners, flavoring, pigments, scents to provide variety to the edible candle product line.

3. A combination of claim 1 where in the mentioned single unit wick-less candle may be coated or dipped by an external coating that will add sweetener, flavoring, coloring or additional fixtures to provide variety to the edible candle product line.

4. A combination of claim 1 wherein the mentioned single unit wick-less candle may be further varied by being molded into various shapes including: numbers, letters, symbols, animals, geographic shapes, volcanos, and cylindrical shapes.

5. An edible solid two unit wick-less candle compromising in combination:
a fiber matrix component capable of wicking composed of loosely interwoven or spongy fine organic fibers mixed with fuel capable of sustaining the flame;
an edible outer moderator and fuel separated from and surrounding the inner fiber matrix component;
the edible fiber matrix component running throughout the interior of the candle;
the combination of which is solid at room temperature and melting at a temperature which is reached when undergoing a combustion reaction; and
said edible double unit candle being capable of maintaining a flame when undergoing a combustion reaction.

6. A combination of claim 5 wherein the mentioned double unit wick-less candle may be varied by adding sweeteners, flavoring, pigments, scents to provide variety to the edible candle product line.

7. A combination of claim 5 where in the mentioned double unit wick-less candle may be coated or dipped by an external coating that will add sweetener, flavoring, coloring or additional fixtures to provide variety to the edible candle product line.

8. A combination of claim 5 wherein the mentioned double unit wick-less candle may be further varied by being molded into various shapes including: numbers, letters, symbols, animals, geographic shapes, volcanos, and cylindrical shapes.

9. An edible solid two unit wick-less torch-like candle compromising in combination:
a fiber matrix component capable of wicking composed of loosely interwoven or spongy fine organic fibers mixed with fuel capable of sustaining the flame;
an edible outer moderator separated from and surrounding the inner fiber matrix component by placing said inner fiber matrix into an extrusion or cavity carved from the outer moderator;
the edible outer moderator being composed of gelatin-based food stuffs, or chocolate, or vanilla, or nuts, or fondant, or toffee, or coconut, or marzipan;
the edible fiber matrix component only being placed within the extrusion or cavity created in the edible outer moderator;
the combination of which is solid at room temperature and melting at a temperature which is reached when undergoing a combustion reaction; and
said edible torch-like candle being capable of maintaining a flame when undergoing a combustion reaction.

10. A combination of claim 9 wherein the mentioned torch-like wick-less candle may be varied by adding sweeteners, flavoring, pigments, scents to provide variety to the edible candle product line.

11. A combination of claim 10 where in the mentioned torch-like wick-less candle may be coated or dipped by an external coating that will add sweetener, flavoring, coloring or additional fixtures to provide variety to the edible candle product line.

12. A combination of claim 10 wherein the mentioned torch-like wick-less candle may be further varied by being molded into various shapes including: numbers, letters, symbols, animals, geographic shapes, volcanos, and cylindrical shapes.

13. An edible solid two unit wick-less torch-like candle compromising in combination:
a fiber matrix component capable of wicking composed of loosely interwoven or spongy fine organic fibers mixed with fuel capable of sustaining the flame;
an edible outer moderator separated from and surrounding the inner fiber matrix component by placing said inner fiber matrix within the interior of the candle;
the edible outer moderator being composed of gelatin-based food stuffs, or chocolate, or vanilla, or nuts, or fondant, or toffee, or coconut, or marzipan;
the edible fiber matrix component composing the center of the candle;
the combination of which is solid at room temperature and melting at a temperature which is reached when undergoing a combustion reaction; and
said edible torch-like candle being capable of maintaining a flame when undergoing a combustion reaction.

14. A combination of claim 13 wherein the mentioned torch-like wick-less candle may be varied by adding sweeteners, flavoring, pigments, scents to provide variety to the edible candle product line.

15. A combination of claim 13 where in the mentioned torch-like wick-less candle may be coated or dipped by an external coating that will add sweetener, flavoring, coloring or additional fixtures to provide variety to the edible candle product line.

16. A combination of claim 13 wherein the mentioned torch-like wick-less candle may be further varied by being molded into various shapes including: numbers, letters, symbols, animals, geographic shapes, volcanos, and cylindrical shapes.
